(19) United States
(12) Patent Application Publication
(10) Pub. No.: US 2021/0128403 A1
(43) Pub. Date: May 6, 2021

(54) Lower limb massage systems and devices, and methods for controlling lower limb massage systems and devices

(71) Applicant: OSIM International Pte. Ltd., Singapore (SG)

(72) Inventors: Kia Tong Tan, Singapore (SG); Ken Tamaki, Osaka (JP); Tsuyoshi Sato, Kawasaki (JP)

(21) Appl. No.: 16/493,262

(22) PCT Filed: Mar. 15, 2017
(86) PCT No.: PCT/SG2017/050127

§ 371 Date: Sep. 11, 2019

(51) Int. Cl. A61H 39/04

(52) U.S. Cl. CPC A61H 39/04; A61H 7/007; A61H 2205/12; A61H 2205/106

(57) ABSTRACT

Embodiments relate to lower limb massage systems having portions forming an L-shaped interior. Tubular portion includes first end section and upper left and right walls. Elongated portion includes second end section and front top and bottom walls. Corner portion is formed between tubular and elongated portions. Corner portion includes lower left and right walls and rear top and bottom walls. First expandable member forms the front top wall portion, and is expandable towards the elongated portion interior. Second expandable member forms the rear top wall portion, and is expandable towards the corner portion interior. Protruding members are positionable below the rear bottom wall and actuatable to protrude towards the corner portion interior. Second expandable member and protruding members cooperate to apply pressure on the bottom of the foot. Protruding members rotate around an axis perpendicular to a line drawn between second end section and bend section of the corner portion.

### BACKGROUND

The present disclosure relates generally to massage systems and devices, and more specifically, to systems, devices, and methods for performing, among other things, purposively targeted massaging of certain body parts, including acupressure points of a lower limb.

Recent advances and improvements in massage technology have enabled users to massage one or more body parts via massage devices. Massage devices include partial or full massage chairs for massaging a user's neck and/or back. Some massage devices also enable users to massage an upper portion of a leg, such as one or more portions of a thigh.

### BRIEF SUMMARY

Present massage devices operate by applying pressure or force to one or more body parts via one or more mechanical protrusions so as to simulate a rubbing and/or kneading action of a masseuse or massage therapist (hereinafter “masseuse”).

It is recognized in the present disclosure that, while present massage devices having mechanical protrusions may be appropriate for certain body parts, such as a back and/or neck portion of a user, mechanical protrusions simulating a rubbing and/or kneading action alone may not be suitable and/or provide for adequate massaging and/or relieving of tension and/or pain for certain other body parts including, but not limited to, one or more portions of the body around and/or below a knee (e.g., calf, ankle, heel, upper and/or lower dorsal portions of the feet, heel, toes and areas around the toes, etc.; hereinafter referred to as the “lower limb”). In particular, conventional mechanical protrusions simulating a rubbing and/or kneading action alone may not be suitable and/or provide for targeted and/or focused pressing of certain pressure points, such as acupressure points of the lower limb.

Present example embodiments relate generally to lower limb massage systems and devices, and methods for controlling lower limb massage systems and devices. Such systems and devices may perform, among other things, targeted massaging of certain body parts, including acupressure points of a lower limb.

In an exemplary embodiment, a lower limb massage system is described. The system may include a main housing, a plurality of expandable members, and one or more protruding members. The main housing may include a plurality of portions cooperatively or adjacently positioned, formed, anchored, secured, in communication with one another, and/or connected (or not connected) to form an L-shaped interior cavity. The portions forming the main housing may include a tubular portion, an elongated portion, and a corner portion. The tubular portion may include at least a first end section at one end of the main housing, an upper left wall, and an upper right wall opposite to the upper left wall. The elongated portion may include at least a second end section at another end of the main housing, a front top wall, and a front bottom wall opposite to the front top wall. The corner portion may be formed between the tubular portion and elongated portion. The corner portion may include at least a lower left wall, lower right wall opposite to the lower left wall, rear top wall, and rear bottom wall opposite to the rear top wall. The plurality of expandable members may include a first expandable member and second expandable member. The first expandable member may be provided in the elongated portion and form at least a portion of the front top wall portion proximal to the second end section. The first expandable member may be configurable to expand towards an interior of the elongated portion. The second expandable member may be provided in the corner portion and form at least a portion of the rear top wall portion, the second expandable member configurable to expand towards an interior of the corner portion. The plurality of expandable members may also include a third expandable member, fourth expandable member, fifth expandable member, sixth expandable member, seventh expandable member, and eighth expandable member. The third expandable member may be provided in the corner portion and may form at least a portion of the lower left wall. The fourth expandable member may be provided in the tubular portion, and may form at least a portion of the upper left wall. The fifth expandable member may be provided in the tubular portion, and may form at least a portion of the upper left wall. The sixth expandable member may be provided in the corner portion, and may form at least a portion of the lower right wall. The seventh expandable member may be provided in the corner portion, and may form at least a portion of the lower right wall. The eighth expandable member may be provided in the tubular portion, and may form at least a portion of the upper right wall. In respect to the one or more protruding members, the one or more protruding members may be configurable to contact with the bottom wall. The one or more protruding members may be positionable below at least the rear bottom wall and actuatable so as to protrude towards the interior of at least the corner portion. The second expandable member and the one or more protruding members may be configurable to cooperate to apply a pressure on at least a portion of the bottom of the foot between the toe portion and the heel portion of the lower limb portion. The one or more protruding members may be configurable to rotate around an axis perpendicular to a line drawn between the second end section and the bend section of the corner portion. The protruding of the one or more protruding members towards the interior of the elongated portion may be controllable via the rotating.

In yet another exemplary embodiment, a processing system is described for controlling a lower limb massage system (e.g., one or more of the systems described above and in the present disclosure). The processing system may include a processor. The processor may be configurable to move (e.g., rotate) one or more protruding members to protrude towards an interior of a main housing (e.g., elongated portion and/or corner portion). The processor may be further configurable to apply a gradually increasing positive pressure (e.g., insertion of a gas and/or liquid) into an expandable member (e.g., the second expandable member described above and in the present disclosure). The processor may be further configurable to move (e.g., rotate), while the positive pressure is being applied, the one or more protruding members in a first direction for a first period of time. The processor may be further configurable to stop movement (e.g., stop rotation), while the positive pressure is being applied, of the one or more protruding members for a second period of time. The processor may be further configurable to move (e.g., rotate), while the positive pressure is being applied, the one or more protruding members in a second direction opposite to the first direction for a third period of time. The processor may be further configurable to stop movement (e.g., stop rotation), while the positive pressure is being applied, of the one or more protruding members for a fourth period of time.

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1A is a perspective view of an example embodiment of a lower limb massage system;

FIGS. 1B-C are left and right side views, respectively, of an example embodiment of a left lower limb massage system;

FIG. 1D is a front view of an example embodiment of a lower limb massage system;

FIG. 2 is an exploded rear side view of an example embodiment of a left lower limb massage system;

FIG. 3 is an example illustration of an example embodiment of a first expandable member and second expandable member;

FIG. 4 is an example illustration of an example embodiment of a third expandable member, fourth expandable member, and fifth expandable member;

FIG. 5 is an example illustration of an example embodiment of a sixth expandable member, seventh expandable member, and eighth expandable member;

FIG. 6A is a perspective view of an example embodiment of the first protruding members, second protruding members, and third protruding members;

FIGS. 6B-C are side views of an example embodiment of the first protruding members, second protruding members, and third protruding members;

FIGS. 7A-E are example illustrations of acupressure points of a lower limb; and

FIG. 8 is an example illustration of an example embodiment of controlling a lower limb massage system using a processor.

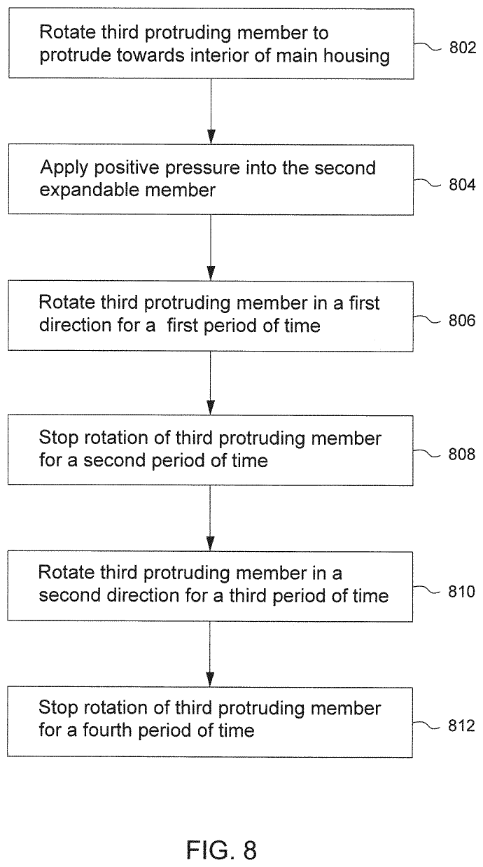

Although similar reference numbers may be used to refer to similar elements in the figures for convenience, it can be appreciated that each of the various example embodiments may be considered to be distinct variations.

Example embodiments will now be described with reference to the accompanying drawings, which form a part of the present disclosure and which illustrate example embodiments which may be practiced. As used in the present disclosure and the appended claims, the terms “example”, “exemplary”, “embodiment”, “example embodiment”, “exemplary embodiment”, and “present embodiment” do not necessarily refer to a single embodiment, although they may, and various embodiments may be readily combined and/or interchanged without departing from the scope, spirit, or teachings of the present disclosure. Furthermore, the terminology as used in the present disclosure and the appended claims is for the purpose of describing example embodiments only and is not intended to be limitations. In this respect, as used in the present disclosure and the appended claims, the term “in” may include “in” and “on”, and the terms “a”, “an”, and “the” may include singular and plural references. Furthermore, as used in the present disclosure and the appended claims, the term “by” may also mean “from”, depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

### DETAILED DESCRIPTION

It is recognized in the present disclosure that conventional approaches to massage technology have enabled users to enjoy a massage and/or relieve tension and/or pain of muscles without the need to engage a masseuse. In general, such massage devices operate by applying pressure and/or force (hereinafter “pressure”) via one or more mechanical protrusions so as to simulate a rubbing and/or kneading action of a masseuse. However, while such conventional massage devices may be appropriate for certain body parts, mechanical protrusions alone may not be suitable for and/or may not allow or provide for adequate massaging and/or relieving of tension and/or pain for certain other body parts, such as one or more portions of a lower limb.

Present example embodiments relate generally to lower limb massage systems, and methods for controlling lower limb massage systems. Such systems may perform, among other things, targeted massaging of certain body parts, including acupressure points, of a lower limb. These systems, and elements thereof, will now be described with reference to the accompanying drawings.

The System (e.g., System 10).

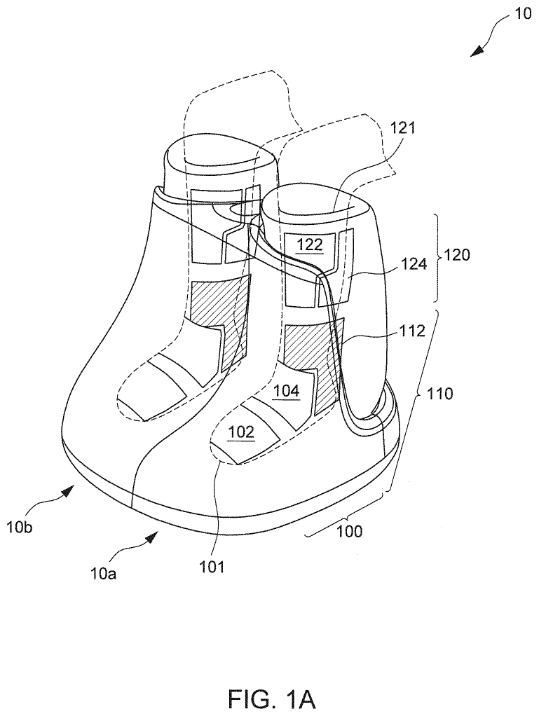

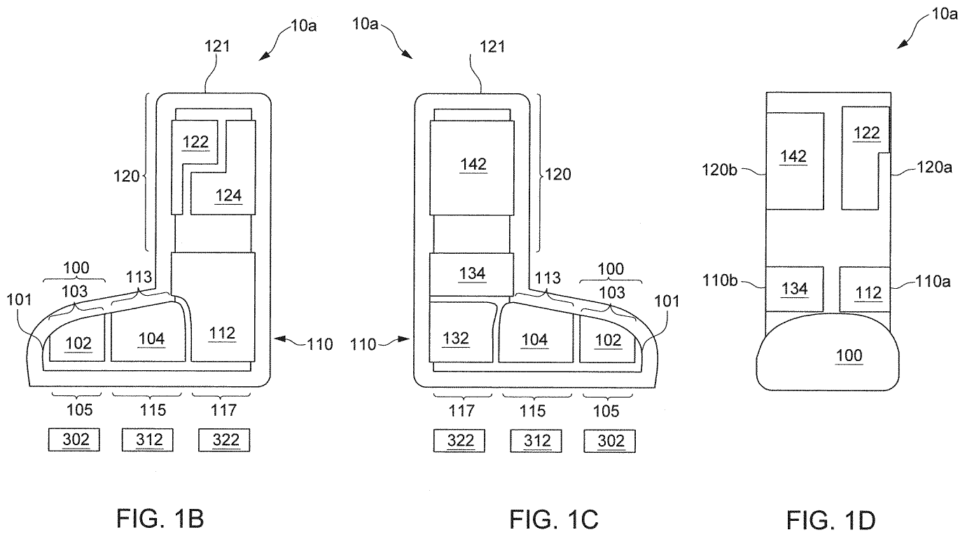

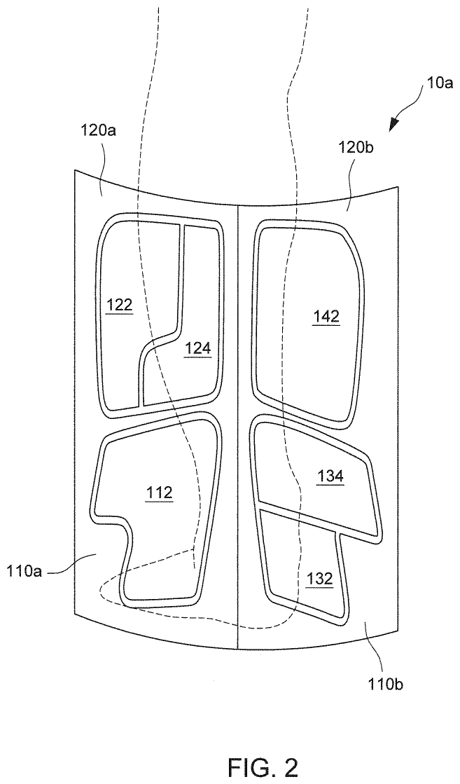

FIG. 1A and FIG. 1D illustrate a perspective and front view, respectively, of an example embodiment of a system 10 for performing a lower limb massage for a user. The system 10 may include a left subsystem (e.g., system 10a) and/or right subsystem (e.g., system 10b). Although the figures may illustrate the system 10 as including both a left subsystem 10a and right subsystem 10b, it is to be understood that the system 10 may also include only one subsystems (e.g., systems 10a or 10b) without departing from the teachings of the present disclosure.

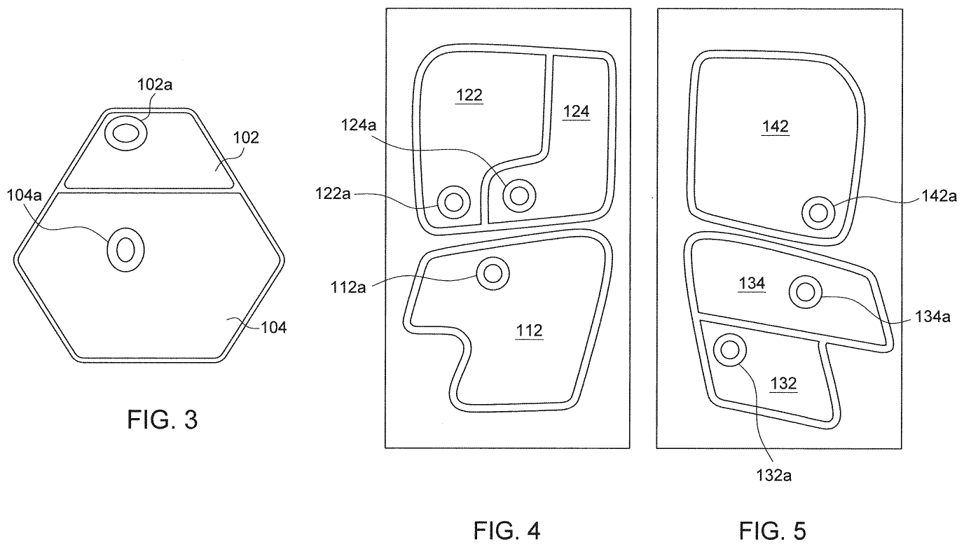

In respect to the left subsystem 10a, FIG. 1B and FIG. 1C illustrate a left and right side view, respectively. An exploded or spread-open rear view of an example embodiment of a portion of the left subsystem 10a is illustrated in FIG. 2.

Although FIG. 1A illustrates the system 10 as being oriented in such a way as to allow a user to sit while the user's left and/or right lower limbs are inserted into the left and/or right subsystems 10 and/or 10b, respectively, it is to be understood that example embodiments of the system 10 may also allow a user to be in other positions (e.g., standing), while operating system 10 without departing from the teachings of the present disclosure. Furthermore, the left subsystem 10a and/or right subsystem may also be oriented in one or more other positions, such as a rotation of +/−90 degrees, or more or less, from the position illustrated in FIG. 1A so as to enable a user to lie down while operating the system 10, without departing from the teachings of the present disclosure.

The system 10 may also include one or more positive pressure sources (not shown) for providing positive pressure into one or more input ports (e.g., an opening, port, or gate) of one or more expandable elements of the system 10. For example, the positive pressure source may include a gas and/or liquid pump for introducing gas and/or liquid into one or more expandable members of the system 10 (e.g., to expand the expandable member) and/or removing gas and/or liquid out of one or more expandable members of the system 10 (e.g., to contract or reduce volume of the expandable member). In some example embodiments, one or more of the expandable members of the system 10 described in the present disclosure may be configurable to expand (or contract or reduce in volume) in other ways, such as via an application (or non-application) of an electrical current, temperature (e.g., heat and/or cold), magnetic field, gas, and/or water to a part (e.g., surface or contact) of the one or more expandable members.

The system 10 may also include one or more processors, controllers, or the like (not shown) configurable or configured to, among other things, control, manage, and/or operate one or more elements of the system 10. The system 10 may also include one or more databases (not shown) configurable to store, among other things, massage sequences, actions to be performed by one or more elements of the system 10, duration for one or more of the actions to be performed (or not performed) by one or more elements of the system 10, user profiles and preferences, histories of one or more user's massages, sections of a lower limb or other body part to massage, acupressure points to focus and/or apply pressure on, amount of pressure to apply, etc.

These and other example embodiments will now be described with reference to the accompanying drawings.

The Left Subsystem (e.g., System 10a).

As illustrated in at least FIGS. 1A-D and FIG. 2A the system 10 may comprise a left subsystem 10a. The left subsystem 10a may be configurable or configured to receive a left lower limb via a main housing of the left subsystem 10a. For example, the main housing and/or an interior cavity formed by the main housing may resemble an exterior and/or interior of a shoe, boot, lower limb, and/or an L-shaped body, or parts thereof. The left subsystem 10a may be configurable or configured to receive a foot, ankle, and/or a portion of a calf of the lower limb. In some example embodiments, the main housing of the left subsystem 10a and the main housing of the right subsystem 10b may be considered, referred to, and/or formed as a single main housing, in which case the single main housing may or may not be separable or separated into separate main housings and/or clearly distinguished as having separate main housings. In an example embodiment, the left subsystem 10a is a mirror image of the right subsystem 10b. Accordingly, any description for an element and/or functionality of an element of the left subsystem 10a described above and in the present disclosure is also equally or substantively apply to an element and/or functionality of a corresponding element of the right subsystem 10b.

The left subsystem 10a may comprise a main housing 10a, including an elongated portion (e.g., elongated portion 100), a tubular portion (e.g., tubular portion 120), and a corner portion (e.g., corner portion 110) adjacently positioned, arranged, formed, anchored, secured, in communication with one another, and/or connected to form an L-shaped interior cavity. The left subsystem 10a may also include one or more expandable members (e.g., first expandable member 102, second expandable member 104, third expandable member 112, fourth expandable member 124, fifth expandable member 122, sixth expandable member 132, seventh expandable member 134, eighth expandable member 142, and/or other expandable members (not shown)). The left subsystem 10a may also comprise one or more first protruding members (e.g., first protruding members 302), one or more second protruding members (e.g., second protruding members 322), one or more third protruding members (e.g., third protruding members 312), one or more other protruding members (not shown), and/or one or more positive pressure sources. These elements of the left subsystem 10a will now be described with reference to the accompanying drawings.

Elongated Portion (e.g., Elongated Portion 100).

In an example embodiment, the left subsystem 10a may include an elongated portion 100. The elongated portion 100 may include an end section (e.g., second end section 101), a top wall portion (e.g., front top wall portion 103), and a bottom wall portion (e.g., front bottom wall portion 105). The elongated portion 100 may also include side walls. As illustrated in at least FIGS. 1A and 1B, the second end section 101 may be configurable or configured to house at least a toe portion of the lower limb (i.e., toes of the foot) when the lower limb is inserted into the elongated portion 100.

In example embodiments, the elongated portion 100 may also include some or all of the rear top wall portion (e.g., rear top wall portion 113), rear bottom wall portion (e.g., rear bottom wall portion 115 and/or 117), lower left wall portion (e.g., lower left wall portion 110a), and/or lower right wall portion (e.g., lower right wall portion 110b).

Corner Portion (e.g., Corner Portion 110).

The left subsystem 10a may also include a corner portion 110. The corner portion 110 may include a bend section, a top wall portion (e.g., rear top wall portion 113), a bottom wall portion (e.g., rear bottom wall portion 115 and/or 117), a left wall portion (e.g., lower left wall portion 110a), and a right wall portion (e.g., lower right wall portion 110b). As illustrated in at least FIG. 1A, the bend portion may be configurable or configured to house at least a heel portion of the lower limb when the lower limb is inserted into the corner portion 110.

In example embodiments, one or more portions of the corner portion 110 may be referred to and/or considered as a part of the elongated portion 100. For example, some or all of the top wall portion 113 may be referred to and/or considered as a part of the elongated portion 100. Furthermore, some or all of the bottom wall portion 115 and/or 117 may be referred to and/or considered as a part of the elongated portion 100.

In example embodiments, some other portions of the corner portion 110 may be referred to and/or considered as a part of the tubular portion 120. For example, some or all of the left wall portion 110a may be referred to and/or considered as a part of the tubular portion 120. Furthermore, some or all of the right wall portion 110b may be referred to and/or considered as a part of the tubular portion 120.

Tubular Portion (e.g., Tubular Portion 120).

The left subsystem 10a may also include a tubular portion 120. The tubular portion 120 may include an end section (e.g., first end section 121), a left wall portion (e.g., upper left wall portion 120a), and a right wall portion (e.g., upper right wall portion 120b). As illustrated in at least FIG. 1A, the end section (e.g., first end section 121) may be configurable or configured to house at least a calf portion of the lower limb when the lower limb is inserted into the tubular portion 120.

In example embodiments, the tubular portion 120 may also include some or all of the rear bottom wall portion 115 and/or 117, lower left wall portion 110a, and/or lower right wall portion 110b.

Expandable Members (e.g., Expandable Members 102, 104, 112, 122, 124, 132, 134, 142).

The left subsystem 10a may also include one or more expandable members (e.g., first expandable member 102, second expandable member 104, third expandable member 112, fourth expandable member 124, fifth expandable member 122, sixth expandable member 132, seventh expandable member 134, eighth expandable member 142, and/or other expandable members (not shown)). Each expandable member may resemble a bag, sack, or the like, that is substantially flat, planar, or contracted when in a normal state, such as when no positive pressure (e.g., air, fluid, etc.) is present, introduced, or being introduced in an interior of the expandable member, and expandable in volume, thickness, protrusions, textures, structures, and/or size when in an expanding or expanded state, such as when a positive pressure (e.g., air, fluid, etc.) is present, introduced, or being introduced in an interior of the expandable member.

Each expandable member may be formed in one or more shapes and sizes and may have one or more walls or membranes made of one or more materials. For example, one or more of the walls of each expandable member may include any form of plastic material such as TPU (Thermal Plastic Polyurethane).

(i) First Expandable Member 102.

In an example embodiment, the left subsystem 10a may include a first expandable member 102 in, proximal to, or adjacent to the second end section 101. For example, the first expandable member 102 may be positionable or positioned to be above the toe portion of the lower limb and/or above a portion of the foot that is adjacent to the toe portion of the lower limb. The first expandable member 102 may form at least a portion of the front top wall portion 103. For example, the first expandable member 102 may form a portion of an interior surface of the front top wall portion 103. As another example, the first expandable member 102 may be embedded within the front top wall portion 103. In this example, the front top wall portion 103 may include a flexible interior layer for contacting with the lower limb and an exterior layer, and first expandable member 102 (positioned between the flexible interior layer and the exterior layer) may push or urge such flexible interior layer towards an interior of the elongated portion 100 when the first expandable member 102 is expanded or expanding. In yet another example, the first expandable member 102 may form a portion of an exterior surface of the front top wall portion 103.

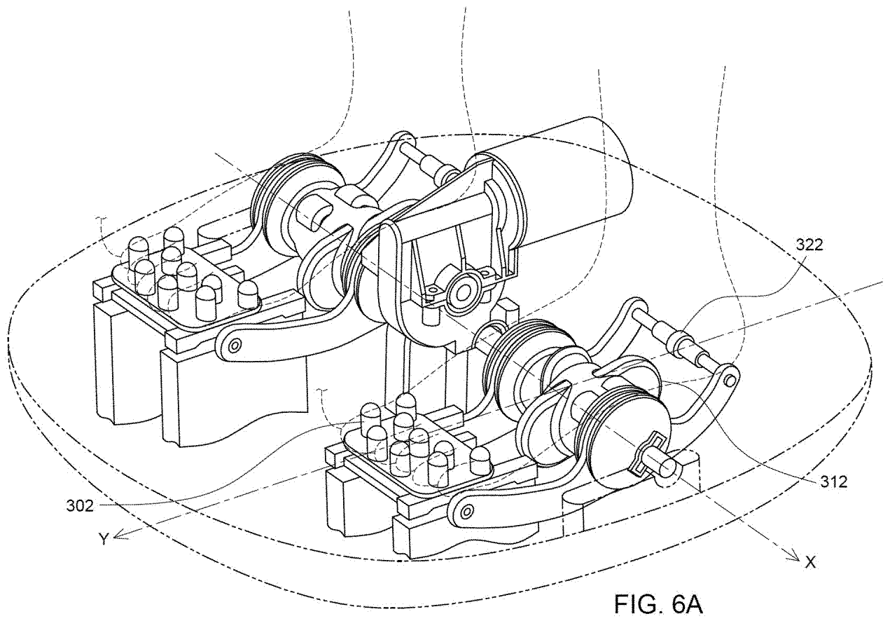

The first expandable member 102 may be configurable or configured to expand towards an interior of the elongated portion 100. For example, the first expandable member 102 may include an input port (e.g., first input port 102a illustrated in FIG. 3) for receiving, from a positive pressure source, an application of a positive pressure (e.g., air, fluid, etc.) into an interior of the first expandable member 102. The processor (not shown) may be configurable or configured to control the amount, rate, and/or duration of the application, by a positive pressure source, of positive pressure (and/or removal of positive pressure or introduction of negative pressure) in the first expandable member 102, and such positive pressure may be controlled independently from and/or together with one or more of the other expandable members (e.g., expandable members 104, 112, 122, 124, 132, 134, and/or 142, as well as one or more of the expandable members of system 10b).

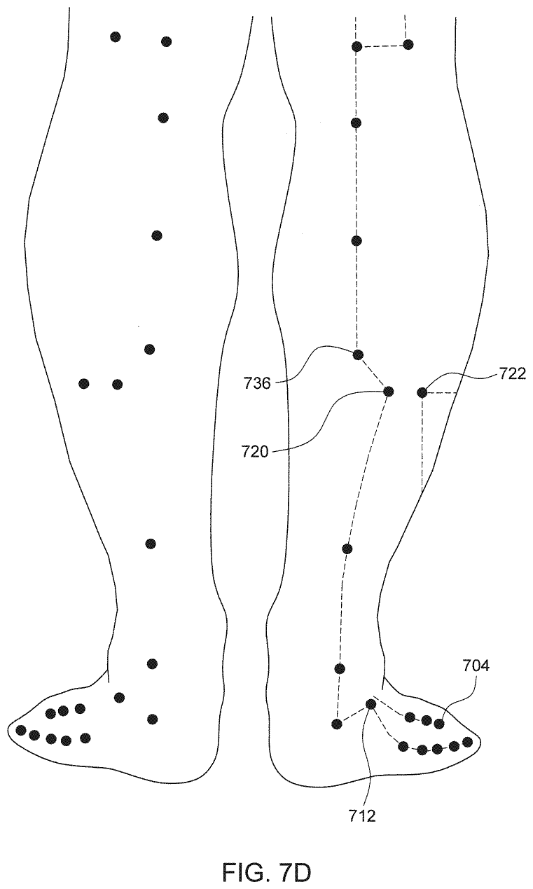

In an example embodiment, one or more sections of the first expandable member 102 may be configurable or configured to purposively expand more (or less) than other sections so as to provide for more targeted or focused application of pressure to one or more particular areas of the lower limb (e.g., at one or more acupressure points). For example, the positive pressure applied to the first expandable member 102 may be selectively controllable to expand the first expandable member 102 in such a way as to apply pressure to one or more acupressure points, such as a Neiting acupressure point 702 and/or a Xiaxi acupressure point 704, as illustrated in at least FIG. 7A and FIG. 7C. In addition to or in replacement, one or more sections of the first expandable member 102 may be configurable or configured to include one or more protrusions, textures, or the like, so as to provide for more targeted or focused application of pressure to one or more particular areas of the lower limb (e.g., at one or more acupressure points), such as to a Neiting acupressure point 702 and/or a Xiaxi acupressure point 704.

The first expandable member 102 may be formed as one or more of a plurality of shapes, sizes, and configurations. For example, as illustrated in FIG. 3, the first expandable member 102 may include a substantially trapezoidal shaped body (when expanded and/or not expanded). Other shapes of the first expandable member 102 are also contemplated without departing from the teachings of the present disclosure so long as the shape, size, and configuration of the first expandable member 102 provide for an application of pressure to one or more acupressure points, such as a Neiting acupressure point 702 and/or a Xiaxi acupressure point 704, when expanded or being expanded. For example, the first expandable member 102 may be substantially triangular in shape, substantially rectangular in shape, substantially hexagonal in shape, semicircular in shape, semi-oval in shape, T-shaped, a combination of one or more of these or other shapes, etc.

(ii) Second Expandable Member 104.

In an example embodiment, the left subsystem 10a may include a second expandable member 104. The second expandable member 104 may be positionable or positioned adjacent to the first expandable member 102 and/or above the dorsal (or mid-section) of the foot. The second expandable member 104 may form at least a portion of the rear top wall portion 113. For example, the second expandable member 104 may form a portion of an interior surface of the rear top wall portion 113. As another example, the second expandable member 104 may be embedded within the rear top wall portion 113. In this example, the rear top wall portion 113 may include a flexible interior layer for contacting with the lower limb and an exterior layer, and second expandable member 104 (positioned between the flexible interior layer and the exterior layer) may push or urge such flexible interior layer towards an interior of the corner portion 110 when the second expandable member 104 is expanded or expanding. In yet another example, the second expandable member 104 may form a portion of an exterior surface of the rear top wall portion 113.

The second expandable member 104 may be configurable or configured to expand towards an interior of the corner portion 110. For example, the second expandable member 104 may include an input port (e.g., second input port 104a illustrated in FIG. 3) for receiving, from a positive pressure source, an application of a positive pressure (e.g., air, fluid, etc.) into an interior of the second expandable member 104. The processor (not shown) may be configurable or configured to control the amount, rate, and/or duration of the application, by a positive pressure source, of positive pressure (and/or removal of positive pressure or introduction of negative pressure) in the second expandable member 104, and such positive pressure may be controlled independently from and/or together with one or more of the other expandable members (e.g., expandable members 102, 112, 122, 124, 132, 134, and/or 142, as well as one or more of the expandable members of system 10b).

In an example embodiment, one or more sections of the second expandable member 104 may be configurable or configured to purposively expand more (or less) than other sections so as to provide for more targeted or focused application of pressure to one or more particular areas of the lower limb (e.g., at one or more acupressure points). For example, the positive pressure applied to the second expandable member 104 may be selectively controllable to expand the second expandable member 104 in such a way as to apply pressure to one or more acupressure points, such as a Chongyang acupressure point 706 and/or a Jiexi acupressure point 708, as illustrated in at least FIGS. 7A and 7C. In addition to or in replacement, one or more sections of the second expandable member 104 may be configurable or configured to include one or more protrusions, textures, or the like, so as to provide for more targeted or focused application of pressure to one or more particular areas of the lower limb (e.g., at one or more acupressure points), such as to a Chongyang acupressure point 706 and/or a Jiexi acupressure point 708.

The second expandable member 104 may be formed as one or more of a plurality of shapes, sizes, and configurations. For example, as illustrated in FIG. 3, the second expandable member 104 may include a substantially hexagonal shaped body (when expanded and/or not expanded). Other shapes of the second expandable member 104 are also contemplated without departing from the teachings of the present disclosure so long as the shape, size, and configuration of the second expandable member 104 provides for an application of pressure to one or more acupressure points, such as a Chongyang acupressure point 706 and/or a Jiexi acupressure point 708, when expanded or being expanded. For example, the second expandable member 104 may be substantially triangular in shape, square in shape, substantially rectangular in shape, substantially hexagonal in shape, circular in shape, oval in shape, a combination of one or more of these or other shapes, etc.

(iii) Third Expandable Member 112.

In an example embodiment, the left subsystem 10a may include a third expandable member 112. The third expandable member 112 may be positionable or positioned to cover at least a portion of the lower limb between a heel of the foot and ankle, and may also cover a portion of the heel and/or a portion above the ankle. The third expandable member 112 may form at least a portion of the lower left wall portion 110a. For example, the third expandable member 112 may form a portion of an interior surface of the lower left wall portion 110a. As another example, the third expandable member 112 may be embedded within the lower left wall portion 110a. In this example, the lower left wall portion 110a may include a flexible interior layer for contacting with the lower limb and an exterior layer, and third expandable member 112 (positioned between the flexible interior layer and the exterior layer) may push or urge such flexible interior layer towards an interior of the corner portion 110 when the third expandable member 112 is expanded or expanding. In yet another example, the third expandable member 112 may form a portion of an exterior surface of the lower left wall portion 110a.

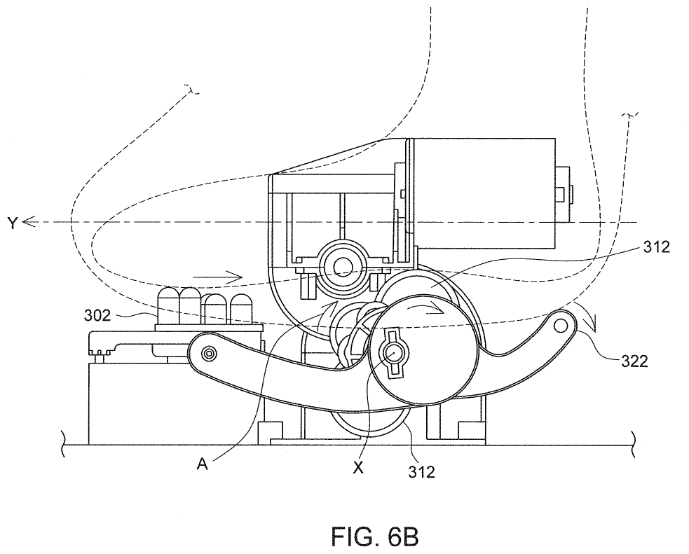

The third expandable member 112 may be configurable or configured to expand towards an interior of the corner portion 110. For example, the third expandable member 112 may include an input port (e.g., third input port 112a illustrated in FIG. 4) for receiving, from a positive pressure source, an application of a positive pressure (e.g., air, fluid, etc.) into an interior of the third expandable member 112. The processor (not shown) may be configurable or configured to control the amount, rate, and/or duration of the application, by a positive pressure source, of positive pressure (and/or removal of positive pressure or introduction of negative pressure) in the third expandable member 112, and such positive pressure may be controlled independently from and/or together with one or more of the other expandable members (e.g., expandable members 102, 104, 122, 124, 132, 134, and/or 142, as well as one or more of the expandable members of system 10b).

In an example embodiment, one or more sections of the third expandable member 112 may be configurable or configured to purposively expand more (or less) than other sections so as to provide for more targeted or focused application of pressure to one or more particular areas of the lower limb (e.g., at one or more acupressure points). For example, the positive pressure applied to the third expandable member 112 may be selectively controllable to expand the third expandable member 112 in such a way as to apply pressure to one or more acupressure points, such as a Pushen acupressure point 710, a Shenmai acupressure point 712, and/or a Jinmen acupressure point 714, as illustrated in at least FIG. 7A. In addition to or in replacement, one or more sections of the third expandable member 112 may be configurable or configured to include one or more protrusions, textures, or the like, so as to provide for more targeted or focused application of pressure to one or more particular areas of the lower limb (e.g., at one or more acupressure points), such as to a Pushen acupressure point 710, a Shenmai acupressure point 712, and/or a Jinmen acupressure point 714.

The third expandable member 112 may be formed as one or more of a plurality of shapes, sizes, and configurations. For example, as illustrated in FIG. 4, the third expandable member 112 may include a substantially L-shaped body (when expanded and/or not expanded). Other shapes of the third expandable member 112 are also contemplated without departing from the teachings of the present disclosure so long as the shape, size, and configuration of the third expandable member 112 provides for an application of pressure to one or more acupressure points, such as a Pushen acupressure point 710, a Shenmai acupressure point 712, and/or a Jinmen acupressure point 714, when expanded or being expanded. For example, the third expandable member 112 may be substantially triangular in shape, square in shape, substantially rectangular in shape, substantially hexagonal in shape, circular in shape, oval in shape, a combination of one or more of these or other shapes, etc.

(iv) Fourth Expandable Member 124.

In an example embodiment, the left subsystem 10a may include a fourth expandable member 124. The fourth expandable member 124 may be positionable or positioned to cover at least a portion of a calf. The fourth expandable member 124 may form at least a portion of the left wall portion 120a. For example, the fourth expandable member 124 may form a portion of an interior surface of the upper left wall portion 120a. As another example, the fourth expandable member 124 may be embedded within the upper left wall portion 120a. In this example, the upper left wall portion 120a may include a flexible interior layer for contacting with the lower limb and an exterior layer, and fourth expandable member 124 (positioned between the flexible interior layer and the exterior layer) may push or urge such flexible interior layer towards an interior of the tubular portion 120 when the fourth expandable member 124 is expanded or expanding. In yet another example, the fourth expandable member 124 may form a portion of an exterior surface of the upper left wall portion 120a.

The fourth expandable member 124 may be configurable or configured to expand towards an interior of the tubular portion 120. For example, the fourth expandable member 124 may include an input port (e.g., fourth input port 124a illustrated in FIG. 4) for receiving, from a positive pressure source, an application of a positive pressure (e.g., air, fluid, etc.) into an interior of the fourth expandable member 124. The processor (not shown) may be configurable or configured to control the amount, rate, and/or duration of the application, by a positive pressure source, of positive pressure (and/or removal of positive pressure or introduction of negative pressure) in the fourth expandable member 124, and such positive pressure may be controlled independently from and/or together with one or more of the other expandable members (e.g., expandable members 102, 104, 112, 122, 132, 134, and/or 142, as well as one or more of the expandable members of system 10b).

In an example embodiment, one or more sections of the fourth expandable member 124 may be configurable or configured to purposively expand more (or less) than other sections so as to provide for more targeted or focused application of pressure to one or more particular areas of the lower limb (e.g., at one or more acupressure points). For example, the positive pressure applied to the fourth expandable member 124 may be selectively controllable to expand the fourth expandable member 124 in such a way as to apply pressure to one or more acupressure points, such as a Feiyang acupressure point 720 and/or a Waiqu acupressure point 722, as illustrated in at least FIG. 7A and FIG. 7D. In addition to or in replacement, one or more sections of the fourth expandable member 124 may be configurable or configured to include one or more protrusions, textures, or the like, so as to provide for more targeted or focused application of pressure to one or more particular areas of the lower limb (e.g., at one or more acupressure points), such as to a Feiyang acupressure point 720 and/or a Waiqu acupressure point 722.

The fourth expandable member 124 may be formed as one or more of a plurality of shapes, sizes, and configurations. For example, as illustrated in FIG. 4, the fourth expandable member 124 may include a substantially L-shaped body (when expanded and/or not expanded). Other shapes of the fourth expandable member 124 are also contemplated without departing from the teachings of the present disclosure so long as the shape, size, and configuration of the fourth expandable member 124 provides for an application of pressure to one or more acupressure points, such as a Feiyang acupressure point 720 and/or a Waiqu acupressure point 722, when expanded or being expanded. For example, the fourth expandable member 124 may be substantially triangular in shape, square in shape, substantially rectangular in shape, substantially hexagonal in shape, circular in shape, oval in shape, a combination of one or more of these or other shapes, etc.

(v) Fifth Expandable Member 122.

In an example embodiment, the left subsystem 10a may include a fifth expandable member 122. The fifth expandable member 122 may be positionable or positioned to cover at least a portion of a calf. The fifth expandable member 122 may form at least a portion of the upper left wall portion 120a. For example, the fifth expandable member 122 may form a portion of an interior surface of the upper left wall portion 120a. As another example, the fifth expandable member 122 may be embedded within the upper left wall portion 120a. In this example, the upper left wall portion 120a may include a flexible interior layer for contacting with the lower limb and an exterior layer, and fifth expandable member 122 (positioned between the flexible interior layer and the exterior layer) may push or urge such flexible interior layer towards an interior of the tubular portion 120 when the fifth expandable member 122 is expanded or expanding. In yet another example, the fifth expandable member 122 may form a portion of an exterior surface of the upper left wall portion.

The fifth expandable member 122 may be configurable or configured to expand towards an interior of the tubular portion 120. For example, the fifth expandable member 122 may include an input port (e.g., fifth input port 122a illustrated in FIG. 4) for receiving, from a positive pressure source, an application of a positive pressure (e.g., air, fluid, etc.) into an interior of the fifth expandable member 122. The processor (not shown) may be configurable or configured to control the amount, rate, and/or duration of the application, by a positive pressure source, of positive pressure (and/or removal of positive pressure or introduction of negative pressure) in the fifth expandable member 122, and such positive pressure may be controlled independently from and/or together with one or more of the other expandable members (e.g., expandable members 102, 104, 112, 124, 132, 134, and/or 142, as well as one or more of the expandable members of system 10b).

In an example embodiment, one or more sections of the fifth expandable member 122 may be configurable or configured to purposively expand more (or less) than other sections so as to provide for more targeted or focused application of pressure to one or more particular areas of the lower limb (e.g., at one or more acupressure points). For example, the positive pressure applied to the fifth expandable member 122 may be selectively controllable to expand the fifth expandable member 122 in such a way as to apply pressure to one or more acupressure points, such as a Shangjuxu acupressure point 716 and/or a Fenglong acupressure point 718, as illustrated in at least FIGS. 7A and 7C. In addition to or in replacement, one or more sections of the fifth expandable member 122 may be configurable or configured to include one or more protrusions, textures, or the like, so as to provide for more targeted or focused application of pressure to one or more particular areas of the lower limb (e.g., at one or more acupressure points), such as to a Shangjuxu acupressure point 716 and/or a Fenglong acupressure point 718.

The fifth expandable member 122 may be formed as one or more of a plurality of shapes, sizes, and configurations. For example, as illustrated in FIG. 4, the fifth expandable member 122 may include a substantially L-shaped body (when expanded and/or not expanded). Other shapes of the fifth expandable member 122 are also contemplated without departing from the teachings of the present disclosure so long as the shape, size, and configuration of the fifth expandable member 122 provides for an application of pressure to one or more acupressure points, such as a Shangjuxu acupressure point 716 and/or a Fenglong acupressure point 718, when expanded or being expanded. For example, the fifth expandable member 122 may be substantially triangular in shape, square in shape, substantially rectangular in shape, substantially hexagonal in shape, circular in shape, oval in shape, a combination of one or more of these or other shapes, etc. In an example embodiment, the fourth expandable member 124 and fifth expandable member 122 may be adjacently positioned in such a way that the collective shape of the fourth expandable member 124 and fifth expandable member 122 resembles a tetragon. Alternatively or in addition, the fourth expandable member 124 and fifth expandable member 122 may be adjacently positioned in such a way that the collective shape of the fourth expandable member 124 and fifth expandable member 122 resembles the shape of the eighth expandable member 142.

(vi) Sixth Expandable Member 132.

In an example embodiment, the left subsystem 10a may include a sixth expandable member 132. The sixth expandable member 132 may be positionable or positioned to cover at least a portion of the lower limb between a heel of the foot and ankle, and may also cover a portion of the heel and/or a portion above the ankle. The sixth expandable member 132 may form at least a portion of the lower right wall portion 110b. For example, the sixth expandable member 132 may form a portion of an interior surface of the lower right wall portion 110b. As another example, the sixth expandable member 132 may be embedded within the lower right wall portion 110b. In this example, the lower right wall portion 110b may include a flexible interior layer for contacting with the lower limb and an exterior layer, and sixth expandable member 132 (positioned between the flexible interior layer and the exterior layer) may push or urge such flexible interior layer towards an interior of the corner portion 110 when the sixth expandable member 132 is expanded or expanding. In yet another example, the sixth expandable member 132 may form a portion of an exterior surface of the lower right wall portion 110b.

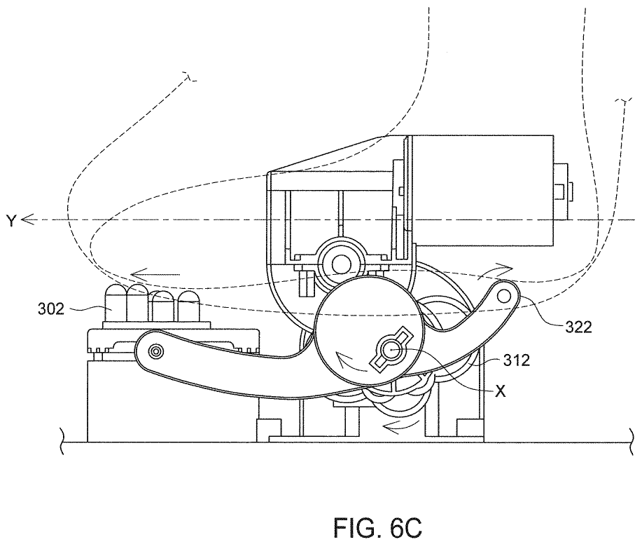

The sixth expandable member 132 may be configurable or configured to expand towards an interior of the corner portion 110. For example, the sixth expandable member 132 may include an input port (e.g., sixth input port 132a illustrated in FIG. 5) for receiving, from a positive pressure source, an application of a positive pressure (e.g., air, fluid, etc.) into an interior of the sixth expandable member 132. The processor (not shown) may be configurable or configured to control the amount, rate, and/or duration of the application, by a positive pressure source, of positive pressure (and/or removal of positive pressure or introduction of negative pressure) in the sixth expandable member 132, and such positive pressure may be controlled independently from and/or together with one or more of the other expandable members (e.g., expandable members 102, 104, 112, 122, 124, 134, and/or 142, as well as one or more of the expandable members of system 10b).

In an example embodiment, one or more sections of the sixth expandable member 132 may be configurable or configured to purposively expand more (or less) than other sections so as to provide for more targeted or focused application of pressure to one or more particular areas of the lower limb (e.g., at one or more acupressure points). For example, the positive pressure applied to the sixth expandable member 132 may be selectively controllable to expand the sixth expandable member 132 in such a way as to apply pressure to one or more acupressure points, such as a Shuiquan acupressure point 724 and/or a Zhaohai acupressure point 726, as illustrated in at least FIG. 7B. In addition to or in replacement, one or more sections of the sixth expandable member 132 may be configurable or configured to include one or more protrusions, textures, or the like, so as to provide for more targeted or focused application of pressure to one or more particular areas of the lower limb (e.g., at one or more acupressure points), such as to a Shuiquan acupressure point 724 and/or a Zhaohai acupressure point 726.

The sixth expandable member 132 may be formed as one or more of a plurality of shapes, sizes, and configurations. For example, as illustrated in FIG. 5, the sixth expandable member 132 may include a substantially tetragonal-shaped body (when expanded and/or not expanded). Other shapes of the sixth expandable member 132 are also contemplated without departing from the teachings of the present disclosure so long as the shape, size, and configuration of the sixth expandable member 132 provides for an application of pressure to one or more acupressure points, such as a Shuiquan acupressure point 724 and/or a Zhaohai acupressure point 726, when expanded or being expanded. For example, the sixth expandable member 132 may be substantially triangular in shape, square in shape, substantially rectangular in shape, substantially hexagonal in shape, circular in shape, oval in shape, a combination of one or more of these or other shapes, etc.

(vii) Seventh Expandable Member 134.

In an example embodiment, the left subsystem 10a may include a seventh expandable member 134. The seventh expandable member 134 may be positionable or positioned to cover a portion of an ankle and/or a portion above the ankle. The seventh expandable member 134 may form at least a portion of the lower right wall portion 110b. For example, the seventh expandable member 134 may form a portion of an interior surface of the lower right wall portion 110b. As another example, the seventh expandable member 134 may be embedded within the lower right wall portion 110b. In this example, the lower right wall portion 110b may include a flexible interior layer for contacting with the lower limb and an exterior layer, and seventh expandable member 134 (positioned between the flexible interior layer and the exterior layer) may push or urge such flexible interior layer towards an interior of the corner portion 110 when the seventh expandable member 134 is expanded or expanding. In yet another example, the seventh expandable member 134 may form a portion of an exterior surface of the lower right wall portion 110b.

The seventh expandable member 134 may be configurable or configured to expand towards an interior of the corner portion 110. For example, the seventh expandable member 134 may include an input port (e.g., seventh input port 134a illustrated in FIG. 5) for receiving, from a positive pressure source, an application of a positive pressure (e.g., air, fluid, etc.) into an interior of the seventh expandable member 134. The processor (not shown) may be configurable or configured to control the amount, rate, and/or duration of the application, by a positive pressure source, of positive pressure (and/or removal of positive pressure or introduction of negative pressure) in the seventh expandable member 134, and such positive pressure may be controlled independently from and/or together with one or more of the other expandable members (e.g., expandable members 102, 104, 112, 122, 124, 132, and/or 142, as well as one or more of the expandable members of system 10b).

In an example embodiment, one or more sections of the seventh expandable member 134 may be configurable or configured to purposively expand more (or less) than other sections so as to provide for more targeted or focused application of pressure to one or more particular areas of the lower limb (e.g., at one or more acupressure points). For example, the positive pressure applied to the seventh expandable member 134 may be selectively controllable to expand the seventh expandable member 134 in such a way as to apply pressure to one or more acupressure points, such as a Jiaoxin acupressure point 728 and/or a Fuliu acupressure point 730, as illustrated in at least FIG. 7B. In addition to or in replacement, one or more sections of the seventh expandable member 134 may be configurable or configured to include one or more protrusions, textures, or the like, so as to provide for more targeted or focused application of pressure to one or more particular areas of the lower limb (e.g., at one or more acupressure points), such as to a Jiaoxin acupressure point 728 and/or a Fuliu acupressure point 730.

The seventh expandable member 134 may be formed as one or more of a plurality of shapes, sizes, and configurations. For example, as illustrated in FIG. 5, the seventh expandable member 134 may include a substantially tetragonal-shaped body (when expanded and/or not expanded). Other shapes of the seventh expandable member 134 are also contemplated without departing from the teachings of the present disclosure so long as the shape, size, and configuration of the seventh expandable member 134 provides for an application of pressure to one or more acupressure points, such as a Jiaoxin acupressure point 728 and/or a Fuliu acupressure point 730, when expanded or being expanded. For example, the seventh expandable member 134 may be substantially triangular in shape, square in shape, substantially rectangular in shape, substantially hexagonal in shape, circular in shape, oval in shape, a combination of one or more of these or other shapes, etc.

(viii) Eighth Expandable Member 142.

In an example embodiment, the left subsystem 10a may include an eighth expandable member 142. The eighth expandable member 142 may be positionable or positioned to cover at least a portion of a calf. The eighth expandable member 142 may form at least a portion of the upper right wall portion 120b. For example, the eighth expandable member 142 may form a portion of an interior surface of the upper right wall portion 120b. As another example, the eighth expandable member 142 may be embedded within the upper right wall portion 120b. In this example, the upper right wall portion 120b may include a flexible interior layer for contacting with the lower limb and an exterior layer, and eighth expandable member 142 (positioned between the flexible interior layer and the exterior layer) may push or urge such flexible interior layer towards an interior of the tubular portion 120 when the eighth expandable member 142 is expanded or expanding. In yet another example, the eighth expandable member 142 may form a portion of an exterior surface of the upper right wall portion 120b.

The eighth expandable member 142 may be configurable or configured to expand towards an interior of the tubular portion 120. For example, the eighth expandable member 142 may include an input port (e.g., eighth input port 142a illustrated in FIG. 5) for receiving, from a positive pressure source, an application of a positive pressure (e.g., air, fluid, etc.) into an interior of the eighth expandable member 142. The processor (not shown) may be configurable or configured to control the amount, rate, and/or duration of the application, by a positive pressure source, of positive pressure (and/or removal of positive pressure or introduction of negative pressure) in the eighth expandable member 142, and such positive pressure may be controlled independently from and/or together with one or more of the other expandable members (e.g., expandable members 102, 104, 112, 122, 124, 132, and/or 134, as well as one or more of the expandable members of system 10b).

In an example embodiment, one or more sections of the eighth expandable member 142 may be configurable or configured to purposively expand more (or less) than other sections so as to provide for more targeted or focused application of pressure to one or more particular areas of the lower limb (e.g., at one or more acupressure points). For example, the positive pressure applied to the eighth expandable member 142 may be selectively controllable to expand the eighth expandable member 142 in such a way as to apply pressure to one or more acupressure points, such as a Zhubin acupressure point 732, Lougu acupressure point 734, and/or a Chengshan acupressure point 736, as illustrated in at least FIGS. 7B-D. In addition to or in replacement, one or more sections of the eighth expandable member 142 may be configurable or configured to include one or more protrusions, textures, or the like, so as to provide for more targeted or focused application of pressure to one or more particular areas of the lower limb (e.g., at one or more acupressure points), such as to a Zhubin acupressure point 732, Lougu acupressure point 734, and/or a Chengshan acupressure point 736.

The eighth expandable member 142 may be formed as one or more of a plurality of shapes, sizes, and configurations. For example, as illustrated in FIG. 5, the eighth expandable member 142 may include a substantially tetragonal-shaped body (when expanded and/or not expanded). Other shapes of the eighth expandable member 142 are also contemplated without departing from the teachings of the present disclosure so long as the shape, size, and configuration of the eighth expandable member 142 provides for an application of pressure to one or more acupressure points, such as a Zhubin acupressure point 732, Lougu acupressure point 734, and/or a Chengshan acupressure point 736, when expanded or being expanded. For example, the eighth expandable member 142 may be substantially triangular in shape, square in shape, substantially rectangular in shape, substantially hexagonal in shape, circular in shape, oval in shape, a combination of one or more of these or other shapes, etc.

First Protruding Member (e.g., First Protruding Member 302).

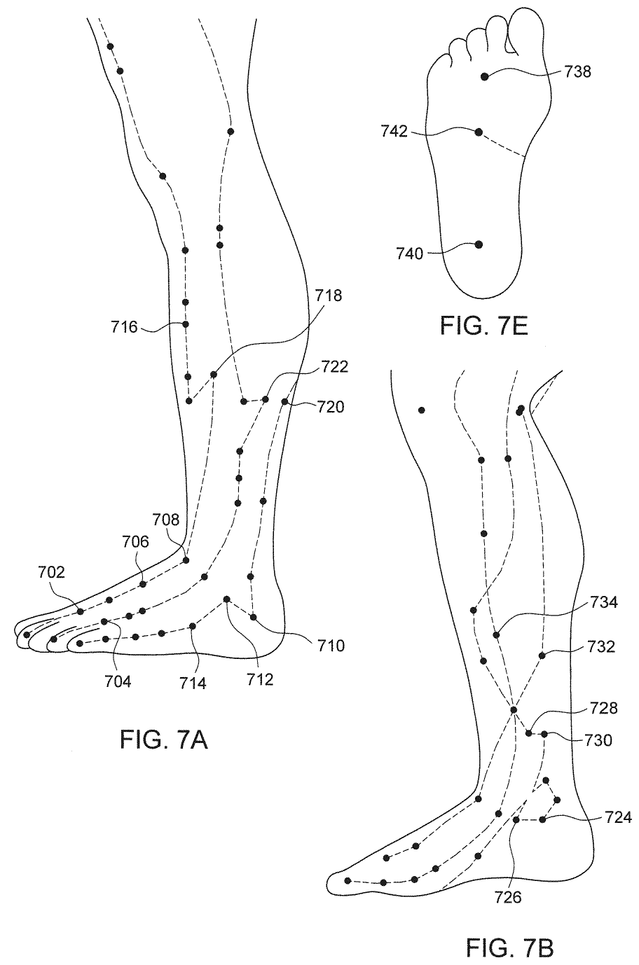

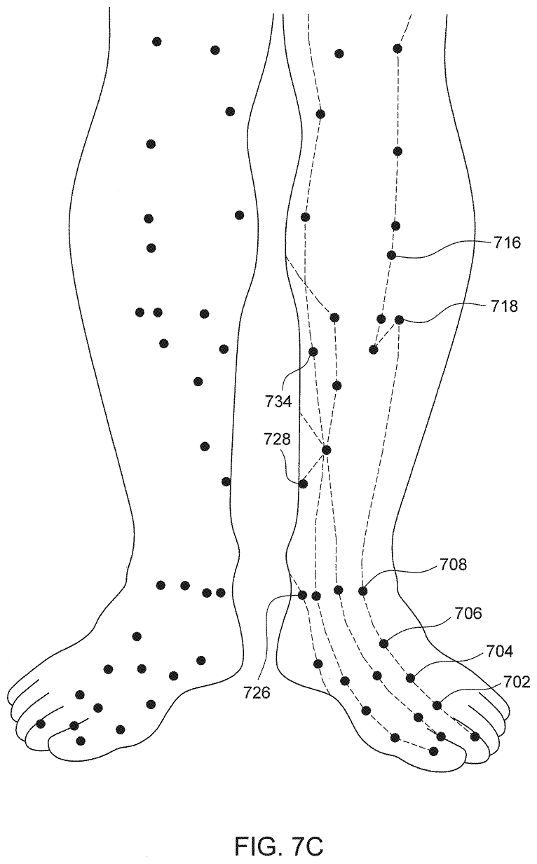

As illustrated in FIGS. 1B-C, FIG. 6A, FIG. 6B, and FIG. 6C, the left subsystem 10a may also include one or more first protruding members (e.g., first protruding member 302) proximal or adjacent to the second end section 101. The one or more first protruding members (e.g., first protruding member 302) may be positionable or positioned to be below the toe portion of the lower limb and/or below a portion of the foot that is adjacent to the toe portion of the lower limb. The one or more first protruding members 302 may be in contact with or movable to be in contact with at least a portion of the bottom wall portion 105.

The one or more first protruding members 302 may be configurable or configured to protrude towards an interior of the elongated portion 100. The processor (not shown) may be configurable or configured to control a movement of the one or more first protruding members 302, and such movement may be controlled independently from and/or together with one or more of the other protruding members (e.g., protruding members 312 and/or 322). In an example embodiment, the pressure applied by the one or more first protruding members 302 may be selectively controllable in such a way as to apply pressure to one or more acupressure points, such as a Lineiting acupressure point 738, as illustrated in at least FIG. 7E.

The one or more first protruding members 302 may be formed as one or more of a plurality of shapes, sizes, and configurations. For example, as illustrated in FIGS. 6A-C, the one or more first protruding members 302 may include substantially elongated bodies having rounded ends. Other shapes of the one or more first protruding members 302 are also contemplated without departing from the teachings of the present disclosure so long as the shape, size, and configuration of the one or more first protruding members 302 provides for an application of pressure to one or more acupressure points, such as a Lineiting acupressure point 738, when expanded or being expanded.

Second Protruding Member (e.g., Second Protruding Member 322).

As illustrated in FIGS. 1B-C and 6A-C, the left subsystem 10a may also include one or more second protruding members (e.g., second protruding member 322) proximal to the bend section of the corner portion 110. The one or more second protruding members 322 may be positionable or positioned to be below the heel portion of the lower limb. The one or more second protruding members 322 may be in contact with or movable to be in contact with at least a portion of the bottom wall portion 117.

The one or more second protruding members 322 may be configurable or configured to protrude towards an interior of the corner portion 110. The processor (not shown) may be configurable or configured to control a movement of the one or more second protruding members 322, and such movement may be controlled independently from and/or together with one or more of the other protruding members (e.g., protruding members 322 and/or 312). In an example embodiment, the pressure applied by the one or more second protruding members 322 may be selectively controllable in such a way as to apply pressure to one or more acupressure points, such as a Shimian acupressure point 740, as illustrated in at least FIG. 7E.

The one or more second protruding members 322 may be formed as one or more of a plurality of shapes, sizes, and configurations. For example, as illustrated in FIGS. 6A-C, the one or more second protruding members 322 may include substantially elongated bodies with one or more protrusions. Other shapes of the one or more second protruding members 322 are also contemplated without departing from the teachings of the present disclosure so long as the shape, size, and configuration of the one or more second protruding members 322 provides for an application of pressure to one or more acupressure points, such as a Shimian acupressure point 740, when expanded or being expanded.

Third Protruding Member (e.g., Third Protruding Member 312).

As illustrated in FIGS. 1B-C and 6A-C, the left subsystem 10a may also include one or more third protruding members (e.g., third protruding member 312) between the one or more first protruding members 302 and the one or more second protruding members 322. The one or more third protruding members 312 may be in contact with or movable to be in contact with at least a portion of the bottom wall portion 115.

The one or more third protruding members 312 may be configurable or configured to protrude towards an interior of the corner portion 110. The processor (not shown) may be configurable or configured to control a movement of the one or more third protruding members 312, and such movement may be controlled independently from and/or together with one or more of the other protruding members (e.g., protruding members 302 and/or 322). In an example embodiment, the pressure applied by the one or more third protruding members 312 may be selectively controllable in such a way as to apply pressure to one or more acupressure points, such as a Yongquan acupressure point 742, as illustrated in at least FIG. 7E.

The one or more third protruding members 312 may be formed as one or more of a plurality of shapes, sizes, and configurations. For example, as illustrated in FIGS. 6A-C, the one or more third protruding members 312 may be rotatable about an axis (e.g., axis X illustrated in FIGS. 6A-C) that is perpendicular to an axis (e.g., axis Y as illustrated in FIGS. 6A-C) or line drawn between the second end section 101 and the bend section of the corner portion 110. Other configurations and/or shapes of the one or more third protruding members 312 are also contemplated without departing from the teachings of the present disclosure so long as the shape, size, and configuration of the one or more third protruding members 312 provides for an application of pressure to one or more acupressure points, such as a Yongquan acupressure point 742, when expanded or being expanded.

The Processor.

In an example embodiment, the system 10 may also comprise one or more processors (not shown). The processor may be a single or unitary element and/or physically separate elements. The processor may be any processor, microprocessor, controller, microcontroller, microchip, mobile device, semiconductor device, or the like, configurable to perform a processing of information and/or other predetermined actions. In an example embodiment, the information processed or processable by the processor may be any information, including information to detect, measure, confirm, actuate or move, prevent or stop from actuating or moving, control, and/or manage a certain movement (or non-movement) of the system 10, 10a, one or more elements of the system 10, 10a, and/or a user of the system 10, 10a. As a non-limiting example, the information processed or processable by the processor may include information pertaining to an action (or non-action) performed by and/or on one or more of the expandable members. As another non-limiting example, the information processed or processable by the processor may include information pertaining to an action (or non-action) performed by and/or on one or more of the protruding members. As another non-limiting example, the information processed or processable by the processor may include information pertaining to an operation (or non-operation) of the one or more positive pressure sources. As another non-limiting example, the information processed or processable by the processor may include information pertaining to one or more sensors (not shown) used to actuate or move, prevent from actuating or moving, control, and/or manage one or more elements of the system 10, 10a. As another non-limiting example, the information processed or processable by the processor may include information pertaining to an applied pressure or force by one or more of the expandable members on at least one portion of the lower limb of the user. As another non-limiting example, the information processed or processable by the processor may include information pertaining to a singular movement and/or sequence of movements (e.g., sequence of massage actions) of the system 10, 10a, one or more elements of the system 10, 10a, and/or the user of the system 10, 10a.

The processor may be configurable or configured to drive, actuate, control, and/or manage the left system 10a, either independently or together, to perform one or more sequences of actions. Such actions may include (or not include) one or more of the elements of the left system 10a described above and in the present disclosure, may include additional elements, may be performed and/or used in different sequences, actions, combinations, and/or configurations than the actions described below and in the present disclosure, and/or one or more of the elements (and/or elements of elements) may be combinable into a single element or divided into two or more elements.

In an example embodiment, the processor may be configurable or configured to rotate the one or more third protruding members 312 to protrude towards the interior of the main housing (e.g., protrude towards the interior of the corner portion 110). For example, a starting point for a massage sequence may be when the one or more third protruding members 312 is rotated and positioned to its highest position (e.g., most protrusion into the corner portion 110, as illustrated in FIG. 6B). The processor may be further configurable or configured to cause one or more positive pressure sources to apply a positive pressure into the second expandable member 104. For example, the positive pressure applied may be a gradually increasing positive pressure (or gradually decreasing negative pressure). The processor may be further configurable or configured to rotate the one or more third protruding members 312 in a first direction (e.g., clockwise or direction A illustrated in FIG. 6B) for a first period of time (e.g., between 0.1 to 5 seconds, or preferably 0.1 to 0.9 seconds). For example, the rotating may be performed while the positive pressure is being applied (and/or increasing or decreasing). The processor may be further configurable or configured to stop the rotation of the one or more third protruding members 312 for a second period of time (e.g., between 0.1 to 5 seconds, or preferably 0.2 to 0.8 seconds). For example, the stopping of the rotation may be performed while the positive pressure is being applied (and/or increasing or decreasing). The processor may be further configurable or configured to rotate the one or more third protruding members 312 in a second direction opposite to the first direction for a third period of time (e.g., between 0.1 to 5 seconds, or preferably 0.2 to 0.9 seconds). For example, the rotating may be performed while the positive pressure is being applied (and/or increasing or decreasing). The processor may be further configurable or configured to stop rotation of the one or more third protruding members 312 for a fourth period of time (e.g., between 0.1 to 5 seconds, or preferably 0.2 to 0.8 seconds). For example, the stopping of the rotation may be performed while the positive pressure is being applied (and/or increasing or decreasing). The processor may be further configurable or configured to move the one or more first protruding members 302 to protrude towards the interior of the main housing (e.g., protrude towards the interior of the corner portion 110). For example, the moving of the first protruding members may be performed while the positive pressure is being applied (and/or increasing or decreasing). The processor may be further configurable or configured to move the one or more second protruding members 322 to protrude towards the interior of the main housing (e.g., protrude towards the interior of the corner portion 110). For example, the moving of the second protruding members may be performed while the positive pressure is being applied (and/or increasing or decreasing). The processor may be further configurable or configured to apply a positive pressure into the first expandable member 102. For example, the positive pressure applied into the first expandable member may be a gradual increasing positive pressure. Furthermore, the application of the positive pressure into the first expandable member may be performed while the positive pressure is being applied (and/or increasing or decreasing).

In respect to the actions described above and in the present disclosure, the processor may be configurable or configured to cooperatively rotate the one or more third protruding members 312 and expand the second expandable member 104 and/or first expandable member 102 in such a way as to apply pressure to one or more acupressure points, including a Yongquan acupressure point 742. Either during, in between, or after one or more of the actions described above and in the present disclosure, the processor may configurable or configured to expand one or more of the expandable members, such as the third expandable member 112, fourth expandable member 124, fifth expandable member 122, sixth expandable member 132, seventh expandable member 134, and/or eighth expandable member 142. Such expanding of the one or more expandable members may be performed by gradually increasing a positive pressure applied into the one or more expandable members.

In an example embodiment, the processor may be configurable or configured to repeat the actions for the elements of the left system 10a in a same order, reverse order, and/or different order, and/or adding or omitting one or more actions, and such repeating may be performed several times, such as between 1-10 times, or preferably 2-6 times.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, as referred to herein, a controller, processor, and/or device may be any computing device or communication device, and may include a virtual machine, computer, node, instance, host, or machine in a networked computing environment.

What is claimed is:

1. A lower limb massage system, the lower limb massage system for receiving a lower limb, including a foot, an ankle, and an upper portion of the lower limb, the lower limb massage system comprising:
a main housing for receiving and housing a lower limb, the main housing having a plurality of portions adjacently arranged to form an L-shaped interior cavity, including:
a tubular portion for housing an upper portion of the lower limb, the tubular portion having at least a first end section at a proximal end of the main housing, the tubular portion formed by an upper left side wall and an upper right side wall opposite to the upper left side wall, the first end section having an opening for allowing an insertion of the lower limb;
an elongated portion for housing the foot, the elongated portion having at least a second end section at a distal end of the main housing, the elongated portion formed by a front top wall and a front bottom wall opposite to the front top wall; and
a corner portion formed between the tubular portion and elongated portion, the corner portion having a corner section separating proximal and distal parts of the corner portion, the proximal part of the corner portion having at least a lower left side wall and lower right side wall opposite to the lower left side wall, the distal part of the corner portion having a rear top wall and rear bottom wall opposite to the rear top wall, the rear bottom wall for use in receiving at least a portion of a heel of the foot;
a plurality of expandable members, including:
a first expandable member provided in the elongated portion and forming at least a portion of the front top wall proximal to the second end section, the first expandable member having a plurality of sections including a first section and a second section, each of the plurality of sections of the first expandable member configurable to expand towards an interior of the elongated portion, wherein the first section of the first expandable member is formed at a first location of the first expandable member that is proximal to a Neiting acupressure point of the foot when the foot is housed in the elongated portion, wherein the second section of the first expandable member is formed at a second location of the first expandable member that is proximal to a Xiaxi acupressure point of the foot when the foot is housed in the elongated portion, wherein the first section of the first expandable member is configured to purposively expand more than at least one other section of the first expandable member that surround the first section of the first expandable member in such a way as to purposively apply more targeted pressure to the Neiting acupressure point, wherein the second section of the first expandable member is configured to purposively expand more than at least one other section of the first expandable member that surround the second section of the first expandable member in such a way as to purposively apply more targeted pressure to the Xiaxi acupressure point;
a second expandable member provided in the corner portion and forming at least a portion of the rear top wall, the second expandable member having a plurality of sections including a first section and a second section, each of the plurality of sections of the second expandable member configurable to expand towards an interior of the corner portion, wherein the first section of the second expandable member is formed at a first location of the second expandable member that is proximal to a Chongyang acupressure point of the foot when the foot is housed in the corner portion, wherein the second section of the second expandable member is formed at a second location of the second expandable member that is proximal to a Jiexi acupressure point of the foot when the foot is housed in the corner portion, wherein the first section of the second expandable member is configured to purposively expand more than at least one other section of the second expandable member that surround the first section of the second expandable member in such a way as to purposively apply more targeted pressure to the Chongyang acupressure point, wherein the second section of the second expandable member is configured to purposively expand more than at least one other section of the second expandable member that surround the second section of the second expandable member in such a way as to purposively apply more targeted pressure to the Jiexi acupressure point;
a third expandable member provided in the corner portion and forming at least a portion of the lower left side wall, the third expandable member having a plurality of sections including a first section, a second section, and a third section, each of the plurality of sections of the third expandable member configurable to expand towards an interior of the corner portion, wherein the first section of the third expandable member is formed at a first location of the third expandable member that is proximal to a Pushen acupressure point of the foot when the foot is housed in the corner portion, wherein the second section of the third expandable member is formed at a second location of the third expandable member that is proximal to a Shenmai acupressure point of the foot when the foot is housed in the corner portion, wherein the third section of the third expandable member is formed at a third location of the third expandable member that is proximal to a Jinmen acupressure point of the foot when the foot is housed in the corner portion, wherein the first section of the third expandable member is configured to purposively expand more than at least one other section of the third expandable member that surround the first section of the third expandable member in such a way as to purposively apply more targeted pressure to the Pushen acupressure point, wherein the second section of the third expandable member is configured to purposively expand more than at least one other section of the third expandable member that surround the second section of the third expandable member in such a way as to purposively apply more targeted pressure to the Shenmai acupressure point, wherein the third section of the third expandable member is configured to purposively expand more than at least one other section of the third expandable member that surround the third section of the third expandable member in such a way as to purposively apply more targeted pressure to the Jinmen acupressure point;
a fourth expandable member provided in the tubular portion and forming at least a portion of the upper left side wall, the fourth expandable member having a plurality of sections including a first section and a second section, each of the plurality of sections of the fourth expandable member configurable to expand towards an interior of the tubular portion, wherein the first section of the fourth expandable member is formed at a first location of the fourth expandable member that is proximal to a Feiyang acupressure point of the lower limb when the lower limb is housed in the tubular portion, wherein the second section of the fourth expandable member is formed at a second location of the fourth expandable member that is proximal to a Waiqu acupressure point of the lower limb when the lower limb is housed in the tubular portion, wherein the first section of the fourth expandable member is configured to purposively expand more than at least one other section of the fourth expandable member that surround the first section of the fourth expandable member in such a way as to purposively apply more targeted pressure to the Feiyang acupressure point, wherein the second section of the fourth expandable member is configured to purposively expand more than at least one other section of the fourth expandable member that surround the second section of the fourth expandable member in such a way as to purposively apply more targeted pressure to the Waiqu acupressure point;
a fifth expandable member provided in the tubular portion and forming at least a portion of the upper left side wall, the fifth expandable member having a plurality of sections including a first section and a second section, each of the plurality of sections of the fifth expandable member configurable to expand towards an interior of the tubular portion, wherein the first section of the fifth expandable member is formed at a first location of the fifth expandable member that is proximal to a Shangjuxu acupressure point of the lower limb when the lower limb is housed in the tubular portion, wherein the second section of the fifth expandable member is formed at a second location of the fifth expandable member that is proximal to a Fenglong acupressure point of the lower limb when the lower limb is housed in the tubular portion, wherein the first section of the fifth expandable member is configured to purposively expand more than at least one other section of the fifth expandable member that surround the first section of the fifth expandable member in such a way as to purposively apply more targeted pressure to the Shangjuxu acupressure point, wherein the second section of the fifth expandable member is configured to purposively expand more than at least one other section of the fifth expandable member that surround the second section of the fifth expandable member in such a way as to purposively apply more targeted pressure to the Fenglong acupressure point;
a sixth expandable member provided in the corner portion and forming at least a portion of the lower right side wall, the sixth expandable member having a plurality of sections including a first section and a second section, each of the plurality of sections of the sixth expandable member configurable to expand towards an interior of the corner portion, wherein the first section of the sixth expandable member is formed at a first location of the sixth expandable member that is proximal to a Shuiquan acupressure point of the portion of the lower limb when the lower limb is housed in the corner portion, wherein the second section of the sixth expandable member is formed at a second location of the sixth expandable member that is proximal to a Zhaohai acupressure point of the lower limb when the lower limb is housed in the corner portion, wherein the first section of the sixth expandable member is configured to purposively expand more than at least one other section of the sixth expandable member that surround the first section of the sixth expandable member in such a way as to purposively apply more targeted pressure to the Shuiquan acupressure point, wherein the second section of the sixth expandable member is configured to purposively expand more than at least one other section of the sixth expandable member that surround the second section of the sixth expandable member in such a way as to purposively apply more targeted pressure to the Zhaohai acupressure point;
a seventh expandable member provided in the corner portion and forming at least a portion of the lower right side wall, the seventh expandable member having a plurality of sections including a first section and a second section, each of the plurality of sections of the seventh expandable member configurable to expand towards an interior of the corner portion, wherein the first section of the seventh expandable member is formed at a first location of the seventh expandable member that is proximal to a Jiaoxin acupressure point of the portion of the lower limb when the lower limb is housed in the corner portion, wherein the second section of the seventh expandable member is formed at a second location of the seventh expandable member that is proximal to a Fuliu acupressure point of the lower limb when the lower limb is housed in the corner portion, wherein the first section of the seventh expandable member is configured to purposively expand more than at least one other section of the seventh expandable member that surround the first section of the seventh expandable member in such a way as to purposively apply more targeted pressure to the Jiaoxin acupressure point, wherein the second section of the seventh expandable member is configured to purposively expand more than at least one other section of the seventh expandable member that surround the second section of the seventh expandable member in such a way as to purposively apply more targeted pressure to the Jiaoxin acupressure point; and
an eighth expandable member provided in the tubular portion and forming at least a portion of the upper right side wall, the eighth expandable member having a plurality of sections including a first section, a second section, and a third section, each of the plurality of sections of the eighth expandable member configurable to expand towards an interior of the tubular portion, wherein the first section of the eighth expandable member is formed at a first location of the eighth expandable member that is proximal to a Zhubin acupressure point of the lower limb when the lower limb is housed in the tubular portion, wherein the second section of the eighth expandable member is formed at a second location of the eighth expandable member that is proximal to a Chengshan acupressure point of the lower limb when the lower limb is housed in the tubular portion, wherein the third section of the eighth expandable member is formed at a third location of the eighth expandable member that is proximal to a Lougu acupressure point of the lower limb when the lower limb is housed in the tubular portion, wherein the first section of the eighth expandable member is configured to purposively expand more than at least one other section of the eighth expandable member that surround the first section of the eighth expandable member in such a way as to purposively apply more targeted pressure to the Zhubin acupressure point, wherein the second section of the eighth expandable member is configured to purposively expand more than at least one other section of the eighth expandable member that surround the second section of the eighth expandable member in such a way as to purposively apply more targeted pressure to the Chengshan acupressure point, wherein the third section of the eighth expandable member is configured to purposively expand more than at least one other section of the eighth expandable member that surround the third section of the eighth expandable member in such a way as to purposively apply more targeted pressure to the Lougu acupressure point;
first and second protruding members extending radially away from a common axis and configurable to rotate around the common axis, the common axis being an axis perpendicular to a line drawn between the second end section of the elongated portion and the corner section of the corner portion, wherein the first and second protruding members are configured to point in different directions, wherein the first and second protruding members are positionable below at least a portion of the rear bottom wall of the corner portion, wherein each of the first and second protruding members are rotatable relative to the common axis in such a way as to switch between protruding towards the interior of the corner portion and not protruding towards the interior of the corner portion, wherein when the corner portion houses the foot, each of the first and second protruding members are configurable to control an amount of pressure applied to a bottom of the foot by controlling the rotation of the protruding member around the common axis, wherein each of the first and second protruding members are configurable to apply a first maximum pressure to the bottom of the foot when the protruding member is rotated to a maximum position;
wherein the second expandable member and each of the first and second protruding members are configurable to cooperate to apply a gradually increasing pressure to the bottom of the foot up to a second maximum pressure by expanding the second expandable member towards the interior of the corner portion of the main housing and rotating each of the first and second protruding members to the maximum position, wherein the second maximum pressure is greater than the first maximum pressure.

2. The lower limb massage system of claim 1, wherein the lower left side wall, lower right side wall, rear top wall, and rear bottom wall are in communication with the upper left side wall, upper right side wall, front top wall, and front bottom wall, respectively.

3. The lower limb massage system of claim 1, wherein:
the first expandable member comprises a first input port, and the first expandable member is configurable to expand towards the interior of the elongated portion upon an application of a positive pressure via the first input port; and
the second expandable member comprises a second input port, and the second expandable member is configurable to expand towards the interior of the corner portion upon an application of a positive pressure via the second input port.

4. The lower limb massage system of claim 1, wherein when a lower limb is inserted into the main housing, the first end section is configurable to house at least a calf portion of the lower limb, the second end section is configurable to house at least a toe portion of the lower limb, and the corner portion is configurable to house at least an ankle and heel portion of the lower limb.

5. The lower limb massage system of claim 1, wherein one or more of the following apply:
the third expandable member includes a substantially L-shaped body;
the fourth expandable member includes a substantially L-shaped body;
the fifth expandable member includes a substantially L-shaped body;
the sixth expandable member includes a substantially tetragonal shaped body;
the seventh expandable member includes a substantially tetragonal shaped body;
the eighth expandable member includes a substantially tetragonal shaped body;
the fourth expandable member and fifth expandable member are adjacently positioned in such a way that the collective shape of the fourth expandable member and fifth expandable member resembles a tetragon;
the fourth expandable member and fifth expandable member are adjacently positioned in such a way that the collective shape of the fourth expandable member and fifth expandable member resembles the shape of the eighth expandable member;
the sixth expandable member and seventh expandable member are adjacently positioned in such a way that the collective shape of the sixth expandable member and seventh expandable member resembles an L-shape; and/or
the sixth expandable member and seventh expandable member are adjacently positioned in such a way that the collective shape of the sixth expandable member and seventh expandable member resembles the shape of the third expandable member.

6. The lower limb massage system of claim 1, wherein one or more of the following apply:
the first expandable member includes a substantially trapezoidal shaped body;
the second expandable member includes a substantially hexagonal shaped body; and/or
the first expandable member and second expandable member are positioned in such a way that at least a portion of the first expandable member is adjacent to the second expandable member and the first expandable member is positioned between the second end section and the second expandable member.

7. The lower limb massage system of claim 1, further comprising one or more positive pressure sources operable to provide positive pressure to one or more of the expandable members.

8. The lower limb massage system of claim 1, wherein one or more of the expandable members are independently expandable.

9. The lower limb massage system of claim 1, wherein one or more of the following apply:
the positive pressure applied to the first expandable member is selectively controllable so as to control the expansion of the first expandable member towards the interior of the elongated portion;
the positive pressure applied to the second expandable member is selectively controllable so as to control the expansion of the second expandable member towards the interior of the corner portion;
the positive pressure applied to the third expandable member is selectively controllable so as to control the expansion of the third expandable member towards the interior of the corner portion;
the positive pressure applied to the fourth expandable member is selectively controllable so as to control the expansion of the fourth expandable member towards the interior of the tubular portion;
the positive pressure applied to the fifth expandable member is selectively controllable so as to control the expansion of the fifth expandable member towards the interior of the tubular portion;
the positive pressure applied to the sixth expandable member is selectively controllable so as to control the expansion of the sixth expandable member towards the interior of the corner portion;
the positive pressure applied to the seventh expandable member is selectively controllable so as to control the expansion of the seventh expandable member towards the interior of the corner portion; and
the positive pressure applied to the eighth expandable member is selectively controllable so as to control the expansion of the eighth expandable member towards the interior of the tubular portion.

10. The lower limb massage system of claim 1, further comprising:
one or more third protruding members configurable to contact with the front bottom wall, the one or more third protruding members proximal to the second end section and actuatable so as to protrude towards the interior of the elongated portion; and
one or more fourth protruding members configurable to contact with the rear bottom wall, the one or more fourth protruding members proximal to a bend section of the corner portion and actuatable so as to protrude towards the interior of the corner portion;
wherein the first expandable member and the one or more first protruding members are configurable to cooperate to apply a pressure on at least a portion of the bottom of the foot proximal to the toe portion of the lower limb, including a Lineiting acupressure point;
wherein the one or more second protruding members are configurable to apply a pressure on at least a heel portion of the foot, including a Shimian acupressure point;
wherein the second expandable member and the one or more third protruding members are configurable to cooperate to apply a pressure on a Yongquan acupressure point.

11. A processing system for controlling the lower limb massage system of claim 1, the processing system comprising:
a processor, the processor configurable to:
rotate the one or more protruding members to protrude towards the interior of the main housing;
apply a gradually increasing positive pressure into the second expandable member;
rotate, while the positive pressure is being applied, the one or more protruding members in a first direction for a first period of time;
stop rotation, while the positive pressure is being applied, of the one or more protruding members for a second period of time;
rotate, while the positive pressure is being applied, the one or more protruding members in a second direction opposite to the first direction for a third period of time; and
stop rotation, while the positive pressure is being applied, of the one or more protruding members for a fourth period of time.

12. The processing system of claim 11, wherein the processor is configurable to:
actuate the one or more second protruding members to protrude towards the interior of the main housing;
actuate the one or more third protruding members to protrude towards the interior of the main housing; and
apply a gradually increasing positive pressure into the first expandable member.

13. The processing system of claim 11, wherein the processor is configurable to cooperatively rotate the one or more protruding members and expand the second expandable member and/or first expandable member in such a way as to apply pressure to one or more acupressure points, including a Yongquan acupressure point.

14. The processing system of claim 11, wherein the processor is configurable to repeat the actions.

15. The processing system of claim 11, wherein one or more of the following apply:
the first direction is a clock-wise direction;
the first period of time is between about 0.1-5 seconds;
the second period of time is between about 0.1-5 seconds;
the third period of time is between about 0.1-5 seconds; and/or
the fourth period of time is between about 0.1-5 seconds.

16. The processing system of claim 11, wherein one or more of the following apply:
the first direction is a clock-wise direction;
the first period of time is between about 0.1-0.9 seconds;
the second period of time is between about 0.2-0.8 seconds;
the third period of time is between about 0.2-0.9 seconds; and/or
the fourth period of time is between about 0.2-0.8 seconds.

17-25. (canceled)
